(19) United States
(12) Patent Application Publication
(10) Pub. No.: US 2009/0171739 A1
(43) Pub. Date: Jul. 2, 2009

(54) Special Occasion Reminder and Gift Giving System

(75) Inventors: Sruba De, Houston, TX (US); Lauren Stephens, Darien, CT (US)

Correspondence Address: HOFFMANN & BARON, LLP, 6900 JERICHO TURNPIKE, SYOSSET, NY, 11791, US

(73) Assignee: MasterCard International, Inc., Purchase, NY (US)

(21) Appl. No.: 12/343,619

(22) Filed: Dec. 24, 2008

Related U.S. Application Data
(60) Provisional application No. 61/017,339, filed on Dec. 28, 2007.

(51) Int. Cl. G06Q 30/00; G06Q 10/00

(52) U.S. Cl. 705/8; 705/26

(57) ABSTRACT

A method for on-line shopping for special occasions includes the steps of providing a link to a network accessible website, receiving and storing data from a user identifying at least one recipient, wherein the data includes at least one special occasion date, sending a notification to the user prior to the special occasion date, wherein the notification reminds the user of the special occasion date, offering a plurality of gifts for on line ordering via the website, receiving and storing an order for a gift in advance of the special occasion date and sending the gift to the recipient a predetermined number of days prior to the special occasion.

### CROSS-REFERENCE TO RELATED APPLICATION

This application claims the benefit of U.S. Provisional Application No. 61/017,339, filed Dec. 28, 2007, which is incorporated herein by reference in its entirety for all purposes.

### BACKGROUND OF THE INVENTION

The present invention relates to commerce in general, and more particularly to a system and method for reminding a consumer of special occasions and for purchasing and sending gifts for the special occasions.

Most people enjoy sending a card and a gift to friends and family members to commemorate important occasions, such as birthdays, graduations and holidays. Often times, checks or money are given in a card for lack of a gift idea. In this regard, gift certificates and gift cards have become increasingly popular. These provide the gift giver with the satisfaction of having purchased a gift, while still allowing the gift recipient to make their own selection.

Today however, consumers are faced with the problem of managing multiple tasks with very little free time to accomplish everything desired. As a result, such important occasions can sometimes be overlooked.

The World Wide Web and Internet, in general, have created a completely new venue in which to obtain information, purchase goods and services and interact with other network users. In particular, the purchase of goods and services over the Internet has become very popular recently. Thus, it is possible to purchase products or services as gifts from the websites of vendors and have them sent to a recipient's address. It is also possible to purchase electronic cards over the Internet to be delivered either to the recipient's e-mail address or printed in hard copy form and delivered to the recipient's postal address.

For example, one known website, www.bigdates.com, allows a user to create profiles of friends and family members together with information pertaining to special dates and occasions. The website will then send reminder e-mails to the user prior to such dates and provide the user with the ability to send a hard copy greeting card or an electronic card (“e-card”) for a fee. The website further provides links to third party vendors for purchasing gifts.

Another web site, www.birthdayalarm.com, allows a user to create profiles with important dates for the purpose of receiving reminder e-mails as the important dates approach. Again, the user has the ability to select/click a link for sending an e-card or select/click a third party vendor link to purchase gifts, such as gift certificates and gift cards.

It is also well known to purchase and send flowers via the Internet. For example, the website www.proflowers.com allows for the creation of recipient profiles and occasions and sends an e-mail reminder to the user 3 to 10 days prior to an approaching occasion. The user is then provided the ability to purchase and send flowers to the recipient.

While such websites have proven convenient, no known service or facility exists that enables a consumer to create and store a database of special occasions, alerts the consumer of the approach of special occasions and allows the consumer to purchase a gift in advance of the special occasion. More specifically, no service exists that allows a consumer to purchase gifts from a single website in advance of an event date for delivery at a specified date.

Accordingly, it would be desirable to provide a method and system for reminding consumers of special occasions or key dates via a reminder and for providing the ability to send gifts easily and in advance of these dates. It would be further desirable to provide a method and system that allows consumers to purchase gifts from a single website offering a full range of merchant gift cards and other gifts, wherein multiple gifts can be purchased well in advance of the event.

### SUMMARY OF THE INVENTION

The present invention provides a method for on-line shopping for special occasions. The method generally includes the steps of providing a link to a network accessible website, receiving and storing data from a user identifying at least one recipient, wherein the data includes at least one special occasion date, sending a notification to the user prior to the special occasion date, wherein the notification reminds the user of the special occasion date, offering a plurality of gifts for on-line ordering via the website, receiving and storing an order for a gift in advance of the special occasion date and sending the gift to the recipient a predetermined number of days prior to the special occasion.

In a preferred embodiment, the method further includes the steps of receiving and storing a personal message from the user and sending the personal message together with the gift. The method also preferably involves the storing of data identifying a plurality of recipients and also preferably includes the step of sending a notification to the user prior to sending the gift to the recipient, wherein the notification alerts the user that a gift is about to be sent. The method further preferably includes the step of displaying a list of recipients to the user via the website and further preferably involves the steps of receiving and storing an annual purchase designation from the user regarding the gift order and sending a gift annually to the recipient a predetermined number of days prior to the special occasion.

The present invention also provides a computer system for on-line shopping for special occasions. The computer system generally includes a processor accessible via a computer network, a memory coupled to the processor for storing data, a network interface coupled to the processor to allow network access to the data, program logic configured to receive and store recipient data from a user, wherein the recipient data identifies at least one recipient and at least one special occasion date, program logic configured to send an electronic notification reminder to the user prior to the special occasion date, wherein the electronic notification reminds the user of the special occasion date, program logic configured to offer a plurality of gifts for on-line ordering by the user, program logic configured to receive and store a gift order in advance of the special occasion date and program logic configured to send a gift to the recipient a predetermined number of days prior to the special occasion.

The present invention further provides a computer program product for use with a computer network having a computer usable medium having program code embodied thereon. The program code generally includes program code for storing data, program code for allowing network access to the data, program code for receiving and storing recipient data from a user, wherein the recipient data identifies at least one recipient and at least one special occasion date, program code for sending an electronic reminder, such as an e-mail, to the user prior to the special occasion date, wherein the electronic notification reminds the user of the special occasion date, program code for offering a plurality of gifts for on-line ordering by the user, program code for receiving and storing a gift order in advance of the special occasion date and program code for sending a gift to the recipient a predetermined number of days prior to the special occasion.

As a result of the present invention, a service is provided that is convenient and valuable to the consumer by delivering reminders as well as gifts to the key recipients. The service is designed to offer a full range of gifts, including gift cards, to suit everyone's needs. The service can be conducted by a single provider or vendor with that single entity fulfilling any placed orders, thus eliminating the need for third party order fulfillment. Moreover, the cardholder can buy all their gifts well in advance and at one time. Other benefits include the ability to store all important dates of friends and family on one site; manage the account and check status; keep a log/history of gifts purchased; and purchase all birthday, anniversary, holiday, etc. gifts at once.

A preferred form of the special occasion reminder and gift-giving system and method, as well as other embodiments, objects, features and advantages of this invention, will be apparent from the following detailed description of illustrative embodiments thereof, which is to be read in conjunction with the accompanying drawings.

### BRIEF DESCRIPTION OF THE DRAWINGS

FIG. 1 is an overall system flow chart setting forth the steps of the method according to the present invention.

FIG. 2 is a screen capture of the graphic user interface for the system of the present invention depicting a dialog screen for inputting reminder and gift recipient information.

FIG. 3 is a screen capture of the graphic user interface for the system of the present invention depicting a sample list of reminder and gift recipient information.

FIG. 4 is a screen capture of the graphic user interface for the system of the present invention depicting a dialog screen for editing reminder and gift recipient information.

FIG. 5 is a screen capture of the graphic user interface for the system of the present invention depicting a higher level dialog box for inputting address and gift card information for a gift recipient.

FIG. 6 is a screen capture of the graphic user interface for the system of the present invention depicting a confirmation box for a gift card purchase.

FIGS. 7A, 7B and 7C show a higher level process flow chart illustrating the gift card fulfillment process.

### DETAILED DESCRIPTION OF THE PREFERRED EMBODIMENTS

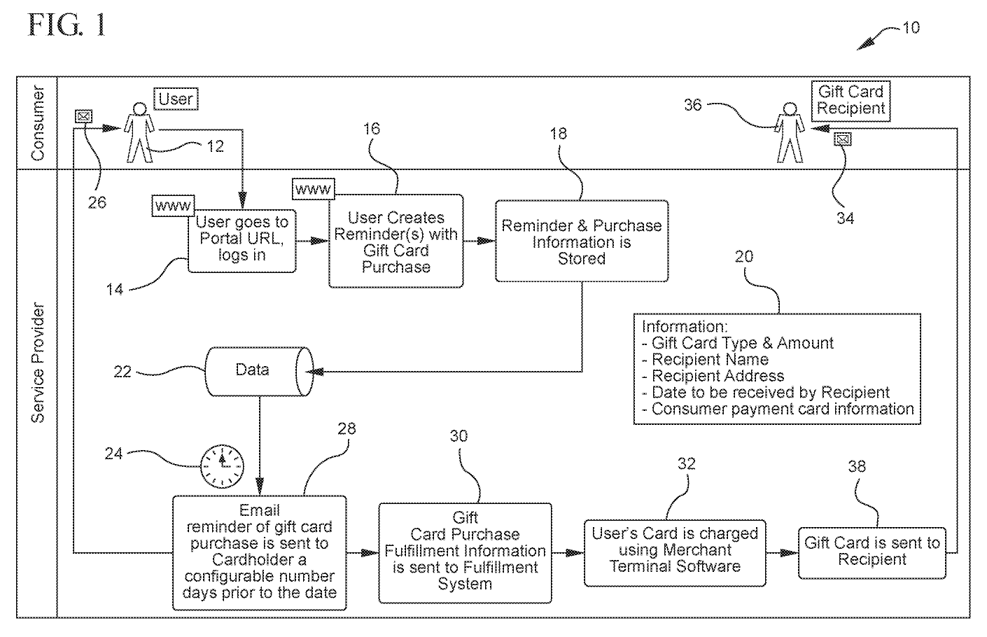

Referring first to FIG. 1, the online application 10 of the present invention generally works as follows. A user 12 enters a portal or network interface 14 and creates a user name and password for security purposes. In step 16, the user 12 then creates a personal profile in which gift recipient names and important dates are input manually or are input automatically, for example, from an e-mail address book. A user may input multiple occasions for each individual gift recipient 36. The user 12 is then able to purchase a gift 34 in advance of an important date 24, or can return at a later time to update the account. In purchasing a gift 34, the user selects from a listing of multiple merchants and a selection of gifts.

While the present invention is particularly well suited for purchasing merchant gift cards, it is not limited to only these types of gift cards. In particular, any type of gift can be offered for sale on the website, including virtual gift cards. Moreover, although the invention is described herein as primarily an online application, it is within the scope of the invention to utilize other forms of communications to input special occasion and reminder information, for example, via telephone or traditional mail.

The user further has the ability to craft a greeting to go along with each gift 34. In step 18, the information 20, including gift type, for example, gift card type and amount, recipient name and address, date to be received by the recipient 36 and user payment information, such as payment card information, entered by the user 12 is stored in a database 22 of the service provider.

As the date 24 of the special occasion approaches, the user 12 receives notification, e.g., via an e-mail 26 stating that a gift or a gift card 34 in the amount of “X” dollars is scheduled to ship for delivery on or about “Y” date, in step 28. The “Y” date is selected to allow sufficient amount of time for the gift 34 to arrive at the recipient 36 on or before the special occasion date 24. Also, the e-mail 26 is preferably sent to the user 12 a sufficient amount of time in advance of the special occasion date 24 so as to provide a grace period for the user to make adjustments to the account or update the account should the user decide to change the gift, the denomination, or simply cancel the gift all together.

Once the grace period elapses, the system 10 sends the gift purchase fulfillment information to a third party gift vendor in step 30. Payment for the gift is transacted in step 32, such as by charging a specified user payment card, and the gift vendor sends a gift or a gift card 34 to the recipient 36 in step 38 on “Y” date. Alternatively, the system provider can itself fulfill the order.

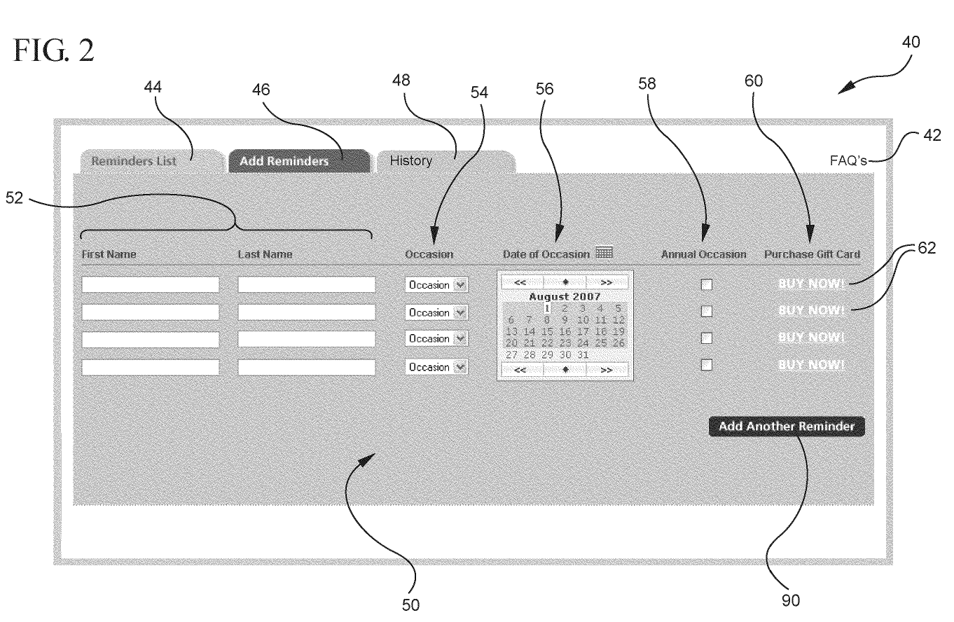

The invention will now be described in further detail with reference to a specific example set forth in FIGS. 2-6. As will be understood by those skilled in the art, other configurations are possible in accordance with the subject invention. The present invention is particularly well suited, for example, as a service provided by a payment card issuer to its cardholders, where the customer information and infrastructure for making electronic purchases is already in place. Such payment card issuers include those issuing credit cards and debit cards.

Thus, payment card holders can be initially notified by e-mail, for example, of the reminder and gift purchasing service being offered by the payment card issuer. The service can be accessible on the Internet, for example, through the card issuer's home website as an option tab or link. Thus, once logging on to the home page and accessing the service link, the user is preferably presented with a main screen 40 and a “learn about” or “FAQ's” link 42. This link will provide a tutorial of the reminder and gift purchasing service which can also be printed using a “print” function provided on the screen.

With reference to FIG. 2, the main page 40 of the reminder and gift purchasing service of the present invention further includes several interactive options tabs including a “Reminders List” tab 44, an “Add Reminders” tab 46 and a “History” tab 48. As shown in FIG. 2, selection of the “Add Reminders” tab 46 presents a dialog box 50, which provides the ability for a cardholder to enter information necessary to set up each special occasion within the application. All special occasions information is entered on the “Add Reminders” tab 46 of the main page 40.

The entered information preferably includes a special occasion recipient's first and last name entered in a name field 52. The names are preferably entered and listed separately and the text can be limited to a fixed number of characters for the first and last name (separately). The First and Last names are required fields.

The Add Reminders dialog box 50 further includes a required Occasion field 54, which provide a list of “occasions” a cardholder can select to be reminded by the service. The list of occasions is preferably configurable by the service provider, but will typically include standard special occasions, such as birthday, graduation and anniversary, and holidays, such as New Year's Day, Valentine's Day, Passover, Easter, Mother's Day, Father's Day, Rosh Hashanah, Yom Kippur, Hanukkah and Christmas. The list of occasions also preferably includes an “other” option, which allows the user to input a custom occasion. Once a custom occasion is created, that occasion is preferably displayed in the drop down occasion listing for re-use.

The Add Reminders dialog box 50 further includes a Date of Occasion field 56, which allows the user to select a date for each occasion. For holidays, the date is fixed to the current year, actual date, wherein the cardholder would not have the ability to select the day of that holiday. The Date of Occasion field 56 is preferably in the form of a calendar including a Month, Day and Year displayed separately.

The Add Reminders dialog box 50 further preferably includes an Annual Occasion field 58, which provides the ability to set up an occasion to recur on an annual basis. The default selection for the Annual Occasion field 58 should be “no,” whereby, if left unchecked, the occasion reminder is automatically set up as a single occurrence reminder. If an occasion is checked for annual reminder, it will automatically remind the cardholder annually during the life of the reminder. Annual reminders can be turned off at any time through the edit function by turning off the annual occasion indicator and then saving the occasion.

The Add Reminders dialog box 50 further includes a Purchase Gift Card field 60, which provides the user the ability to purchase a gift card from a selection of third-party vendors. The Purchase Gift Card field 60 includes an indication of the gift status for the respective reminder, such as, for example, “BUY NOW!” or “PURCHASED” indicators 62. Thus, in this preferred embodiment, when a gift card has been purchased, the status should state “PURCHASED” and when a gift card has not been purchased, the status should state “BUY NOW!”

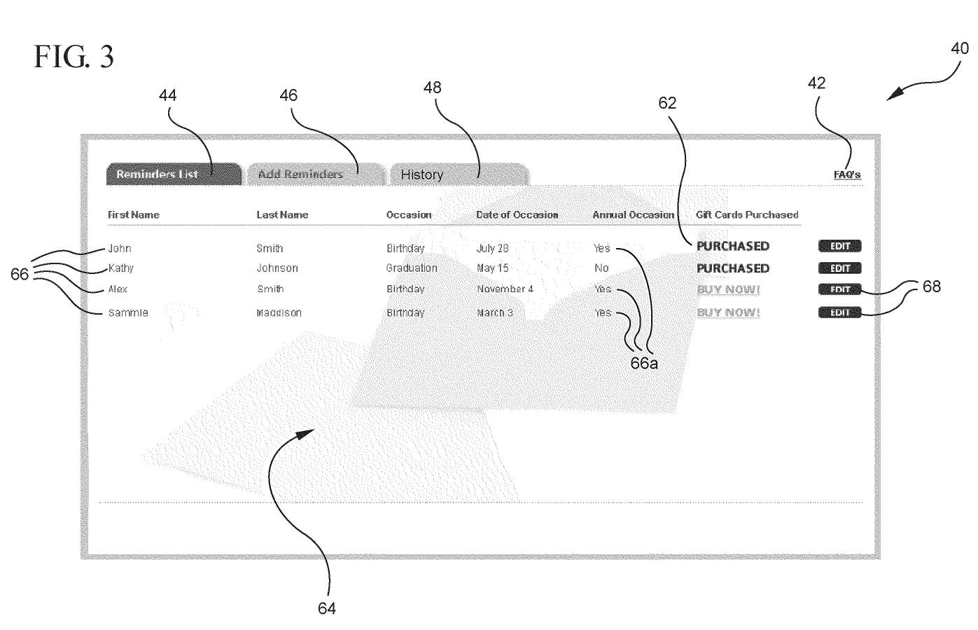

Once the reminder information has been input, it can be displayed by selecting the Reminders List tab 44, as shown in FIG. 3. Selection of the Reminders List tab 44 displays a Reminders List screen 64 listing all the cardholder's special occasion reminders 66 on one screen. For annual occasions 66a displayed on the Reminders List screen 64, only the current reminder is shown. Once that reminder has passed, the next current annual reminder for that occasion will be shown. All future reminders are preferably displayed on the Reminders List screen 64, sorted by year, wherein the current year is displayed as the default, but a cardholder could scroll down to see the upcoming reminders/purchases. All scheduled reminders 62 that have not occurred in the current year, and are saved in the system, may be displayed on the Reminders List screen 64 with the following information, although other configurations are possible: Recipient's First Name; Recipient's Last Name; Occasion; Date of Occasion (Month Day, Year); Annual Occasion (Yes/No); and Gift purchased (Purchased or Buy Now).

Selection of the History tab 48 will display a History screen (not shown) listing all past reminder information. Such information can be accessed by the user to determine, for example, if a gift was sent in previous years and what the actual gift encompasses. If a gift is purchased and the request sent to the payment card issuer for fulfillment, the status will display on the History tab for the shipped gift. The History screen further displays a listing of any gift purchases that were declined. In such case, the status of “Declined” will appear on the History screen. If a payment transaction fails to go through, e.g., a user's payment card is declined, the system of the present invention will contact the cardholder via e-mail to the cardholder's default e-mail address of record, text (SMS) message, or any other method, stating the information for that request (i.e., gift or gift card specifics) and then instructing the cardholder to contact the payment card issuer. Next to the “Declined” status shown on the History screen, a window or envelop is preferably displayed and a hover is provided over the display, which, when the computer cursor is brought over this spot, shows the same content as in the e-mail message transmitted with respect to the declined transaction.

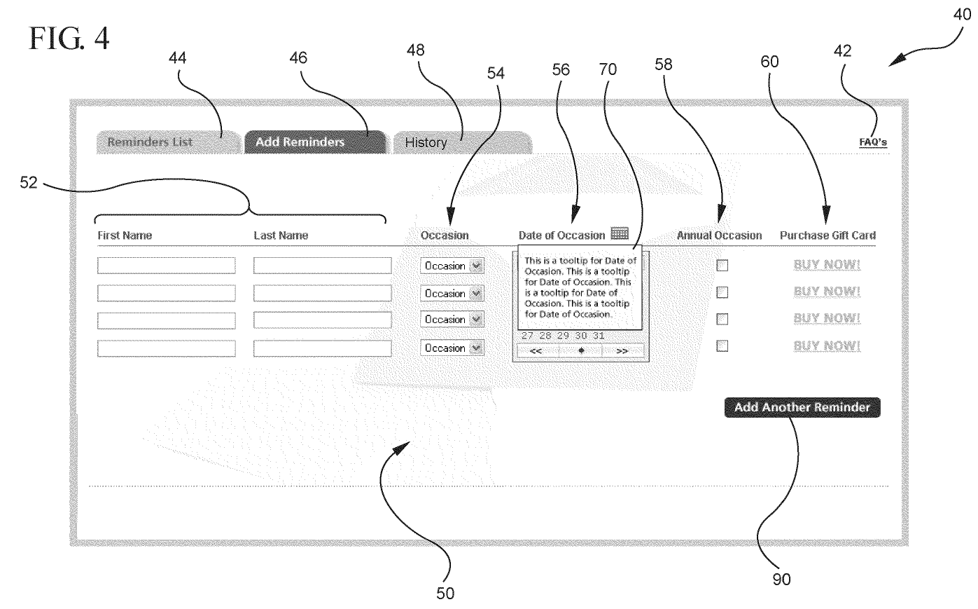

Each of the Add Reminder dialog screen 50, the Reminders List screen 64 and the History screen are preferably provided with tool tips 70, as shown in FIG. 4, which aid the user in navigating the respective screen. Tool tips 70 are designed to display when the user “mouses” over a respective header (e.g., calendar) in a known manner.

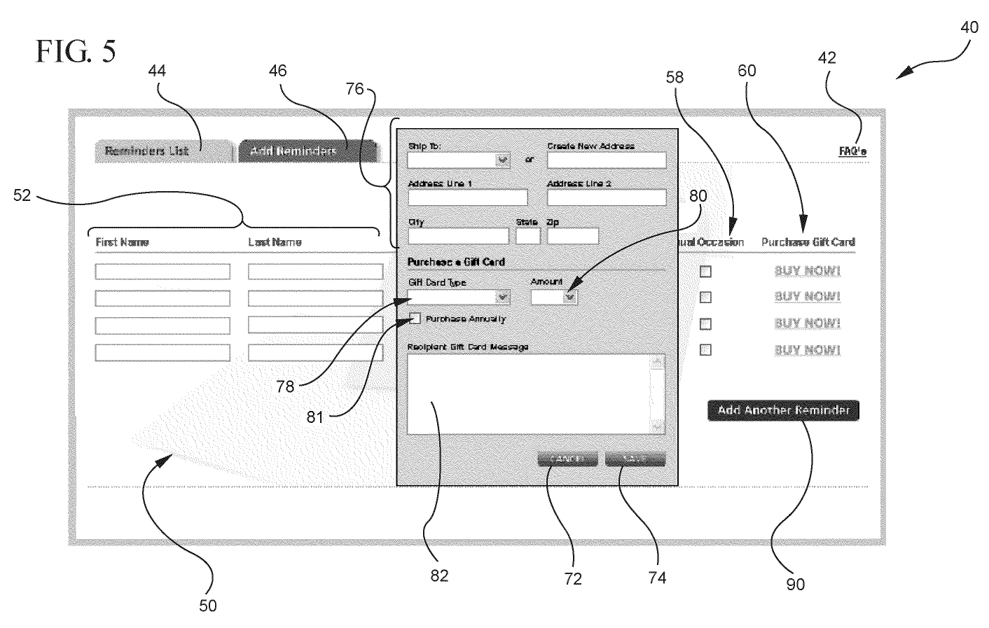

The Reminders List screen 64, shown in FIG. 3 further preferably includes an edit button 68 for each reminder 66. Selection of the edit button 68 allows the user to edit the selected reminder 66. When the edit button 68 is selected for a reminder entered 66, all information for that reminder is displayed on the Add Reminders screen 50 in an edit mode, as shown in FIG. 5. In edit mode, an edit box 71 is displayed wherein Recipient First and Last Name, Shipping Address 1-2, City, State, Zip, Occasion, Date of Occasion, Gift or Gift Card purchased, and Annual Occasion are all editable fields.

The edit box 71 further preferably includes a “CANCEL” button 72 and a “SAVE” button 74. The Cancel button 72 provides the ability for the user to delete a reminder. When a reminder is marked for deletion, the entire reminder is removed. Preferably, no history will be removed when a reminder is deleted, so that the user can refer back to the reminder if desired. If a gift card has been requested with an occasion reminder, deleting the reminder will cancel any pending, but unprocessed, transactions.

The edit box 71 includes a recipient information field 76, where the user is able to enter the gift recipient's full mailing address. Once a recipient's information has been entered and saved in the system, that name is applied to a drop down menu so a user can easily retrieve that information to send them multiple gift cards. If a cardholder selects a recipient from the drop down menu, the shipping fields are automatically filled. The edit box 70 further allows the shipping address to be changed to an alternate address if so desired, for example, to a work location.

Gift cards are also purchased in the edit box 71. In this regard the edit box 71 includes a gift card purchase drop down menu 78 and a purchase amount field 80. The gift card purchase drop down menu 78 displays a list of all the gift card types available through the service provider. Preferably, the service provider has prearranged with a large number of third party vendors in order to offer a vast variety of gifts and gift card purchases to the user at the single website. If purchasing a gift card, the user can select the type of gift card from the drop down menu 78 and can enter the amount of the gift card in the amount field 80.

The edit box 71 further preferably includes a “Purchase Annually” field 81 allowing the user to have the gift automatically sent each year by checking a “Purchase Annually” check box. Purchase annually is not an option on a one-time event. Thus, the Annual Occasion check box 58 must be checked in order to set up a Purchase Annual gift card.

The edit box 71 further preferably includes a personal message field 82 allowing the user to input a personal message to accompany the gift. The personal message can be printed on a card and mailed to the recipient along with the gift card, or e-mailed to the recipient at an address designated by the sender. Alternatively, or in addition, a personal message can be imprinted directly on the gift card. However, a personal message is not required to purchase and send a gift or gift card.

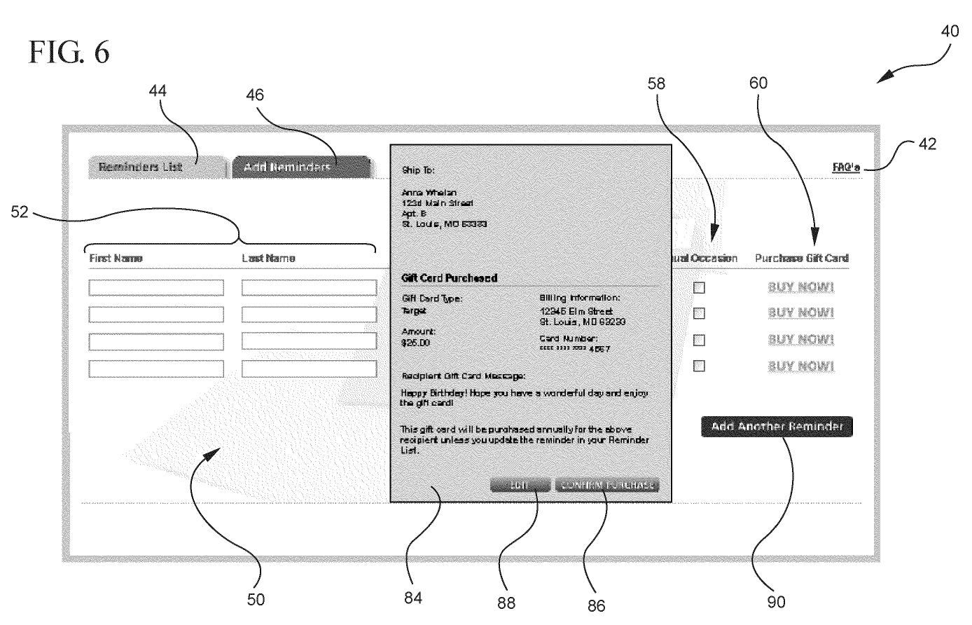

Once a user has entered the recipient information, the type of gift or gift card to be purchased, the amount, if purchasing a gift card, and any desired personal message into the edit screen 71, the user selects the “SAVE” button 74, which causes a confirmation dialog box 84 to display, as shown in FIG. 6. The confirmation dialog box 84 provides the user with the ability to preview and edit any information before confirming their gift or gift card purchase. The confirmation screen 84 displays the information associated with the gift or gift card, for example; recipient name and shipping information; gift card (type); denomination of gift card; billing address for charging the purchase of the gift card; last four digits of the user's payment card for validation; estimated delivery date of the gift card; gift card personal message; and a message indicating whether the purchase is an annual purchase. The annual purchase message to the cardholder will alert the cardholder that they will be charged for this particular purchase annually, and that the same card will be sent out to this recipient each year.

The confirmation dialog box 84 also includes a “Confirm Purchase” button 86 and an “Edit” button 88. Selecting the Confirm Purchase button 86 saves the information for processing based on the occasion date and changes the Gift Cards Purchased label 62 in the Reminders List screen 64 from “BUY NOW!” to “PURCHASED,” as shown in FIG. 3. Selecting the Confirm Purchase button 86 also causes a confirmation message to display to the cardholder that states, for example, “Your information has been saved and processed.” Selecting the Edit button 88 reverts the screen back to the edit mode screen 71, as shown in FIG. 5, and allows the cardholder to make changes, or to cancel the order altogether.

Once the purchase is confirmed, the user is provided the ability to add another reminder in the same session. In this regard, an “Add Another Reminder” button 90 is preferably provided on the Add Reminders screen 50. The system preferably provides for duplicate reminders for the same recipient and occasion (i.e., follow-up reminders), as well as reminders for multiple occasions for the same recipient and reminders for a single occasion with different recipients. Each is preferably set up and saved before creating or editing another reminder.

The system of the present invention further preferably sends some form of reminder to the user reminding the user of an upcoming special occasion or event. This reminder is separate from a gift or gift card purchase. The reminders can be sent electronically via the user's preferred method, for example, to the user's e-mail address stored in their profile, or as a text message to the user's cell phone. A reminder can be set up to be sent a preset number of days in advance of the special occasion or event.

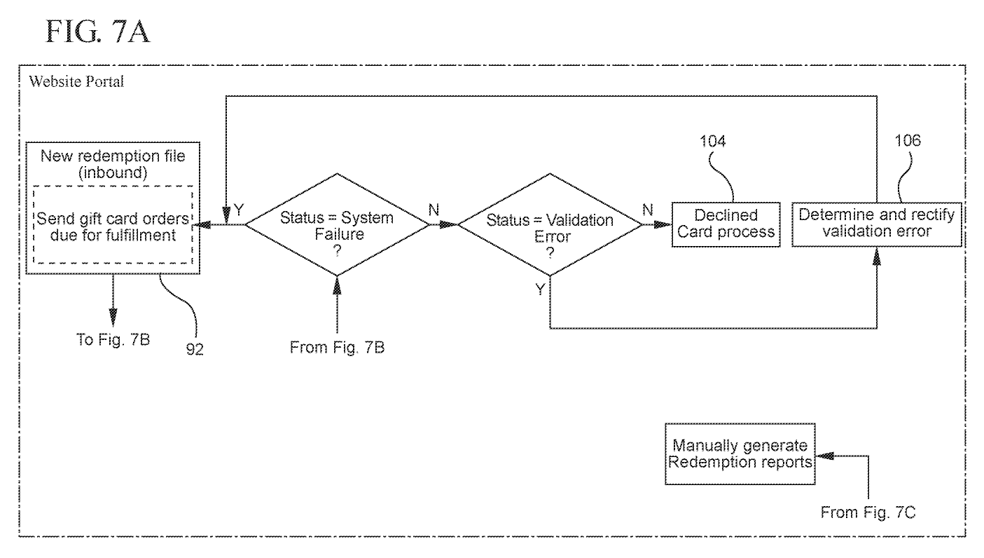

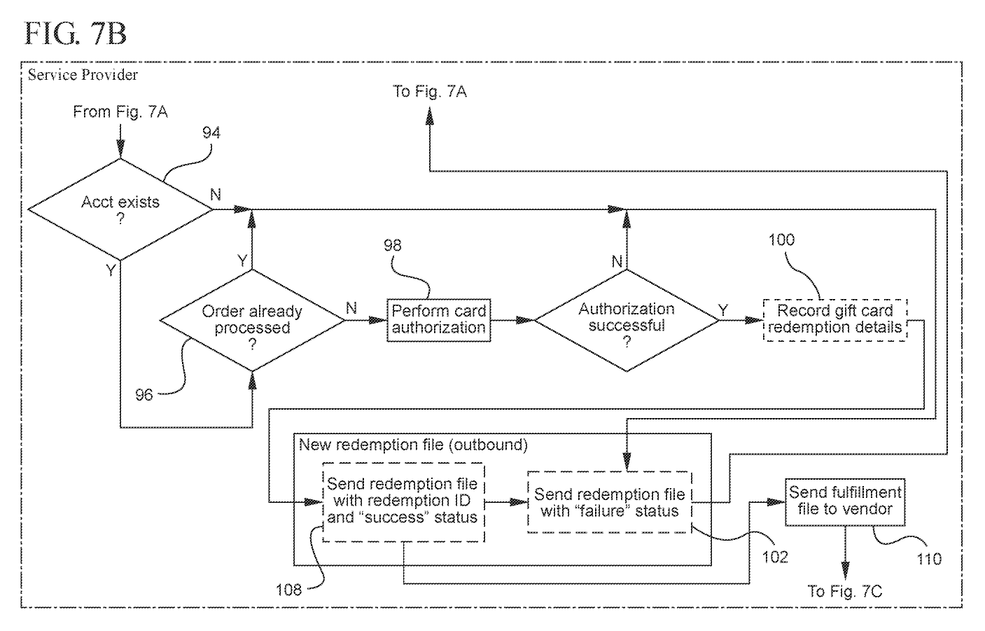

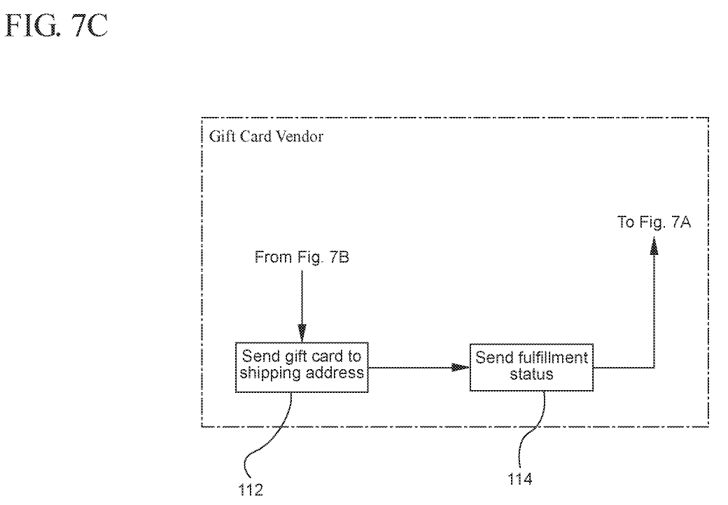

Referring now to FIGS. 7A, 7B and 7C, the gift card request is submitted in step 92 to the payment card issuer for processing a predetermined amount of time prior to the occasion date. If the reminder being set up is for an occasion with a date that is due to occur prior to passage of the predetermined amount of time, the user is prompted that the card may not be shipped for delivery on time. The user can then be prompted with an option to accept and continue the order, or to cancel the request.

In steps 94 and 96, the service provider will first verify if an account exists and determine if the particular transaction was already processed. Payment card authorization is then performed in step 98 and gift card redemption details are recorded in a redemption file in step 100. If any problems occur during these steps, the service provider sends a failure status back to the website in step 102, where a declined card process 104 or an error determination and rectification process 106 can be initiated.

If the payment transaction is declined for some reason, the gift card purchase request is canceled and the system generates an electronic notification, such as an e-mail to the card holder explaining that the request was declined and directing them to contact their card issuer's customer service department. Also, the status of the order in the Reminders List screen 64 is changed to indicate that there is no longer a card “purchased” for this occasion and the reminder history information is updated with a “Declined” indicator. The reminder, however, will remain valid.

If the status code is successful, the redemption file is labeled “success” in step 108 and the file is sent to a vendor in step 110. The vendor fulfills the gift purchase and sends the gift to the recipient in step 112, and, in step 114, a fulfillment status is sent back to the website.

Once the fulfillment status is sent back to the website, the “Gift Card Purchased” status in the Reminders List screen 64 in FIG. 3 can be changed to “shipped.” The service provider further preferably sends an electronic notification, such as an e-mail to the cardholder indicating that the order was processed using the cardholder's payment card and approximately when their gift card will be delivered.

When a gift card order has been sent, the Gift Cards Purchased label 62 on the Reminders List screen 64 is changed to “SHIPPED” and an e-mail is preferably sent to the cardholder confirming shipment. The e-mail preferably includes a link back to the system website 40, which allows the user to review the gift card order. For occasions where a gift card is purchased and shipped, the History screen will display a redemption ID under a “tracking number.”

Although illustrative embodiments of the present invention have been described herein with reference to the accompanying drawings, it is to be understood that the invention is not limited to those precise embodiments, and that various other changes and modifications may be effected by one skilled in the art without departing from the scope or spirit of the invention. For example, the particular screen captures of FIGS. 2-6 are illustrative of a preferred embodiment of the present invention. As such, it is within the scope of the present invention to utilize other interfaces to enter and display this information and to utilize some subset of the information discussed herein. Similarly, although e-mail communication is discussed herein as a preferred method of transmitting reminders, other forms of notifications can be utilized, such as text messaging, automated phone calls, traditional mail service, and the like.

What is claimed is:

1. A method for on-line shopping for special occasions comprising the steps of:
providing a link to a network accessible website;
receiving and storing data from a user identifying at least one recipient, said data including at least one special occasion date;
sending a notification to said user prior to said special occasion date, said notification reminding said user of said special occasion date;
offering a plurality of gifts;
receiving and storing an order for a gift in advance of said special occasion date; and
sending said gift to said recipient a predetermined number of days prior to said special occasion.

2. A method as defined in claim 1, further comprising the steps of:
receiving and storing a personal message from said user; and
sending said personal message together with said gift.

3. A method as defined in claim 1, wherein data identifying a plurality of recipients is received and stored.

4. A method as defined in claim 1, further comprising the step of sending a notification to said user prior to sending said gift to said recipient, said notification alerting said user that a gift is about to be sent.

5. A method as defined in claim 1, further comprising the step of displaying a list of recipients to said user via said website.

6. A method as defined in claim 1, further comprising the steps of:
receiving and storing an annual purchase designation from said user regarding said gift order; and
sending a gift annually to said recipient a predetermined number of days prior to said special occasion.

7. A computer system for on-line shopping for special occasions comprising:
a processor accessible via a computer network;
a memory coupled to said processor for storing data;
a network interface coupled to said processor to allow network access to said data;
program logic configured to receive and store recipient data from a user, said recipient data identifying at least one recipient and at least one special occasion date;
program logic configured to send an electronic notification reminder to said user prior to said special occasion date, said electronic notification reminder reminding said user of said special occasion date;
program logic configured to offer a plurality of gifts for on line ordering by said user;
program logic configured to receive and store a gift order in advance of said special occasion date; and
program logic configured to send a gift to said recipient a predetermined number of days prior to said special occasion.

8. A computer system as defined in claim 7, further comprising:
program logic configured to receive and store a personal message from said user; and
program logic configured to send said personal message together with said gift.

9. A computer system as defined in claim 7, wherein recipient data identifying a plurality of recipients is received and stored.

10. A computer system as defined in claim 7, further comprising program logic configured to send an electronic notification to said user prior to sending said gift to said recipient, said electronic notification alerting said user that a gift is about to be sent.

11. A computer system as defined in claim 7, further comprising program logic configured to display a list of recipients to said user via said website.

12. A computer system as defined in claim 7, further comprising:
program logic configured to receive and store an annual purchase designation from said user regarding said gift order; and
program logic configured to send a gift annually to said recipient a predetermined number of days prior to said special occasion.

13. A computer program product for use with a computer network having a computer usable medium having program code embodied thereon, the program code comprising:
program code for storing data;
program code for allowing network access to said data;
program code for receiving and storing recipient data from a user, said recipient data identifying at least one recipient and at least one special occasion date;
program code for sending an electronic notification reminder to said user prior to said special occasion date, said electronic notification reminder reminding said user of said special occasion date;
program code for offering a plurality of gifts for on line ordering by said user;
program code for receiving and storing a gift order in advance of said special occasion date; and
program code for sending a gift to said recipient a predetermined number of days prior to said special occasion.

14. A computer program product as defined in claim 13, further comprising:
program code for receiving and storing a personal message from said user; and
program code for sending said personal message together with said gift.

15. A computer program product as defined in claim 13, wherein recipient data identifying a plurality of recipients is received and stored.

16. A computer program product as defined in claim 13, further comprising program code for sending an electronic notification to said user prior to sending said gift to said recipient, said electronic notification alerting said user that a gift is about to be sent.

17. A computer program product as defined in claim 13, further comprising program code for displaying a list of recipients to said user via said website.

18. A computer program product as defined in claim 13, further comprising:
program code for receiving and storing an annual purchase designation from said user regarding said gift order; and
program code for sending a gift annually to said recipient a predetermined number of days prior to said special occasion.
